(19) United States
(12) Patent Application Publication
(10) Pub. No.: US 2003/0053224 A1
(43) Pub. Date: Mar. 20, 2003

(54) Micro-optical beam steering angle magnifier

(76) Inventor: Donald Bruns, San Diego, CA (US)

Correspondence Address: EASTMAN & ASSOCIATES, Suite 306, 520 West Ash Street, San Diego, CA, 92101, US

(21) Appl. No.: 09/960,272

(22) Filed: Sep. 20, 2001

(51) Int. Cl. G02B 9/04; G02B 27/02

(52) U.S. Cl. 359/793

(57) ABSTRACT

A micro-optical beam steering angle magnifier, including an input light source (such as a laser), a double-convex input lens, and a double-convex output lens. The input light source emits an input light beam at a specified input angle with respect to the optical axis, toward the input lens. The input lens directs the input light beam to the output lens. The output lens outputs the light beam at an output angle of magnitude 5 times (but sign opposite) that of the input angle. Other types of lenses may be used with varying degrees of quality and maximum output angle. The invention may be used with beams that are collimated or aberrated.

### FIELD OF THE INVENTION

The present invention relates to micro-optical beam steerers, and methods for steering micro-optical beams. The present invention is particularly, though not exclusively, useful for increasing the maximum output angle of micro-optical beam steerers by using lenses to magnify the angle of a micro-optical beam with respect to the optical axis.

### BACKGROUND OF THE INVENTION

A micro-optical beam steerer is used to steer a micro-optical beam to a desired location by changing the angle of the beam with respect to the optical axis. The range of output angles of many micro-optical beam steerers is about plus or minus 3 degrees. Some users of micro-optical systems have required larger-angle beam steering devices to replace older systems. For example, in some cases, micro-optical breadboards have been developed, and a larger-angle beam steering component has been needed for such breadboards.

Accordingly, it is an object of the present invention to provide a micro-optical beam steering angle magnifier, to accomplish such larger-angle beam steering.

### SUMMARY OF THE PRESENT INVENTION

The present invention is a micro-optical beam steering angle magnifier.

It is one possible component of a micro-optical system, for accomplishing larger-angle beam steering. Using this magnifier, the range of the angle of a beam from a conventional micro-optical beam steerer, can be increased to about plus or minus 15 degrees. Thus, a single beam can be made to cover a wider target area.

The present invention incudes an input lens and an output lens positioned so that an input beam from a micro-optical beam steerer can pass through both lenses. The beam exits the magnifier as an output beam at an angle that is magnified with respect to the angle of the input beam by about 5 times.

An advantage of the present invention is that it is compatible with existing or near-term micro-optical systems.

### DESCRIPTION OF THE DRAWINGS

The novel features of this invention, as well as the invention itself, both as to its structure and its operation, will be best understood from the accompanying drawings, taken in conjunction with the accompanying description, in which like reference characters refer to similar parts, and in which:

FIG. 1 is a side view of a first preferred embodiment of the present invention showing an input beam with an input angle of 0 degrees with respect to the optical axis;

FIG. 2 is a side view of a first preferred embodiment of the present invention showing an input beam with an input angle of −4 degrees with respect to the optical axis;

FIG. 3 is a side view of a first preferred embodiment of the present invention showing an input beam with an input angle of +4 degrees with respect to the optical axis; and

FIG. 4 is an end view of a preferred embodiment of the present invention showing the steering of an input beam in multiple planes.

### DETAILED DESCRIPTION

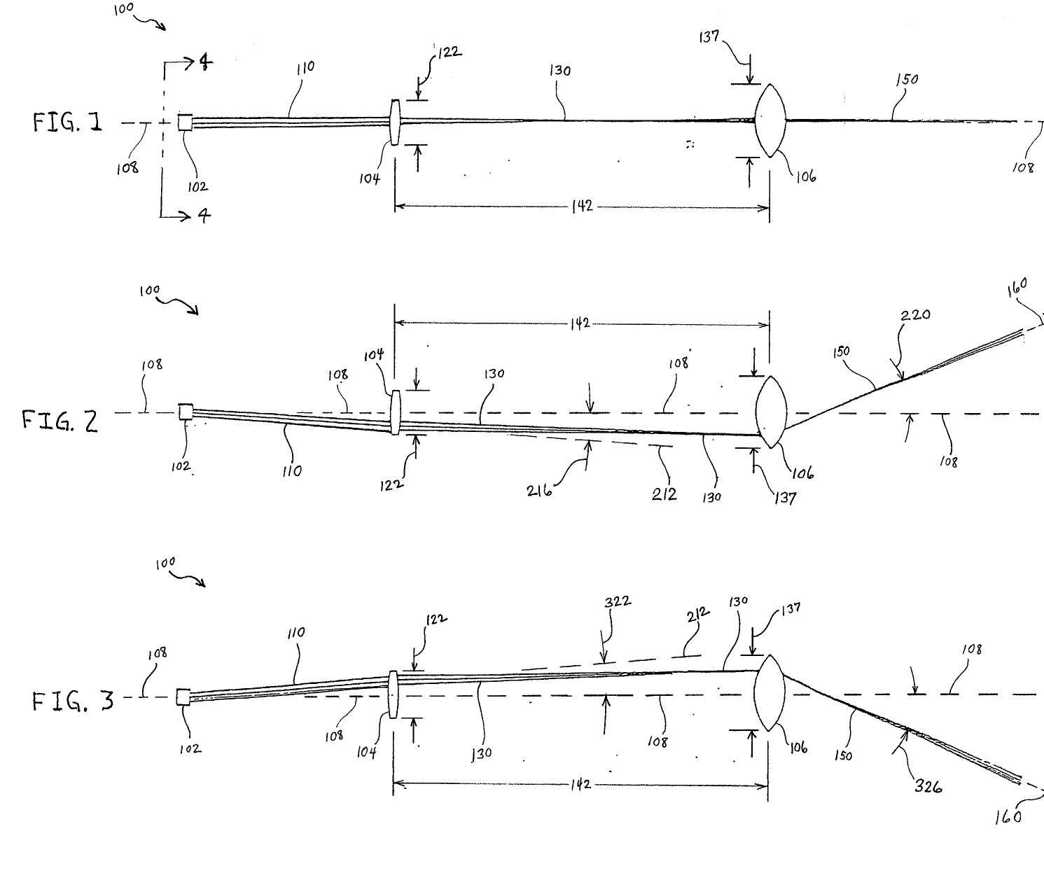

Referring initially to FIG. 1, a side view of the first preferred embodiment of the Micro-Optical Beam Steering Magnifier is shown and generally designated 100. Magnifier 100 includes an input source 102, an input lens 104, an output lens 106, and an optical system axis 108. Input source 102 may be paraxial with system axis 108. Alternatively, input source 102 may be non-paraxial with system axis 108. Input source 102 may be a diode laser mounted on a micro-optical bench. Alternatively, input source 102 may be any other optical source, including but not limited to, a light-reflective micro-mirror, an optical fiber, etc. Input source 102 outputs an optical input beam 110. Input beam 110 has an optical input axis. In FIG. 1, the input axis is coaxial with system axis 108. If, in the alternative, input source 102 is non-paraxial with system axis 108, then the input axis will be non-coaxial with system axis 108. The input axis forms an input angle (not shown in FIG. 1) with system axis 108. For purposes of this discussion, in FIGS. 1, 2 and 3, the sign of angles with respect to system axis 108 are taken as positive in the direction toward the top of the figure, and negative in the direction toward the bottom of the figure. The input angle is not shown in FIG. 1 because in FIG. 1 the input angle is zero (0) degrees. In FIG. 1, input beam 110 is shown as collimated. Input beam 110 may alternatively be aberrated, divergent, convergent, etc. Input light 110 travels from input source 102 to input lens 104. Input lens 104 has an optical axis which may be coaxial with system axis 108. Alternatively, the optical axis of input lens 104 may be non-coaxial with system axis 108. Input lens 104 has a diameter 122, which may be equal to 0.15 mm. Alternatively, diameter 122 may be in the range from 0.001 mm to 0.3 mm. As yet another alternative, diameter 122 may be greater than 0.3 mm. Input lens 104 has a focal length which may be equal to 1 mm. Alternatively, the focal length of input lens 104 may be in the range from 0.001 mm to 2 mm. As yet another alternative, the focal length of input lens 104 may be greater than 2 mm. Input beam 110 passes through input lens 104. In FIG. 1, input beam 110 is shown as narrower than input lens 104. If input beam 110 is not wider than input lens 104, then no power of input beam 110 is lost when input beam 110 moves across input lens 104. Alternatively, input beam 110 may be wider than or the same width as input lens 104.

Input beam 110 exits input lens 104 as an intermediary beam 130. Input lens 104 directs intermediary beam 130 to output lens 106. Output lens 106 has an optical axis which may be coaxial with system axis 108. Alternatively, the optical axis of output lens 106 may be non-coaxial with system axis 108. Output lens 106 has a diameter 137, which may be equal to 0.25 mm. Alternatively, diameter 137 may be in the range from 0.001 mm to 0.5 mm. As yet another alternative, diameter 137 may be greater than 0.5 mm. The focal length of output lens 106 may be equal to 0.2 mm. Alternatively, the focal length of output lens 106 may be in the range from 0.001 mm to 0.4 mm. As yet another alternative, the focal length of output lens 106 may be greater than 0.4 mm. Output lens 106 is a distance 142 from input lens 104. Distance 142 may be about 1.2 mm. Alternatively, distance 142 may be in the range from 0.001 mm to 2.4 mm. As yet another alternative, distance 142 may be greater than 2.4 mm.

Intermediary beam 130 passes through output lens 106 and exits output lens 106 as an output beam 150. Output beam 150 has an optical output axis 160. Output axis 160 forms an output angle (not shown in FIG. 1) with system axis 108. The output angle is not shown in FIG. 1 because in FIG. 1 the output angle is zero (0). The absolute magnitude of the output angle is equal to the magnitude of the input angle multiplied by an angular magnification factor M, which depends on the construction of output lens 106 and input lens 104. The sign of the output angle is opposite to that of the input angle.

If the input angle and output angle are small (close to zero), angular magnification factor M is equal to the ratio of the focal lengths of output lens 106 and input lens 104. If output lens 106 is a simple refractive lens, the maximum value of M is about five (5). With alternative types of lenses, such as holographic or fresnel lenses, for example, the maximum value of M can be about ten (10). If M is about 5, and the range of the input angle is, for example, about +/−5 degrees, then the range of the output angle is about +/−25 degrees. Alternatively, if the range of the input angle is about +/−3 degrees, and M is about 5, then the range of the output angle is about +/−15 degrees. With alternative types of lenses, such as holographic or fresnel lenses, for example, the range of the output angle can be about +/−50 degrees. In FIG. 1, because the input angle is zero degrees, the output angle is zero degrees.

In FIG. 1, input lens 104 and output lens 106 are shown as double-convex lenses. Double-convex lenses are among the easiest types of lenses to make using standard micro-optical techniques. Either or both input lens 104 and output lens 106 may alternatively include, but are not limited to, multiple elements, holographic elements, Fresnel lenses, aspheric elements, piano-convex lenses, meniscus lenses, etc. The choices may depend on the desired output quality of magnifier 100. The desired output quality may include higher-quality diffraction-limited beams, or spoiled beams which spread over a larger area.

The maximum value of the output angle is determined by the construction of output lens 106. Where output lens 106 is a refractive double-convex lens, made of material having a refractive index of about 1.5, the maximum value of the output angle is about +/−25 degrees. Alternatively, the maximum value of the output angle can be about +/−50 degrees depending upon the construction of output lens 106. For example, if output lens 106 is a holographic or Fresnel lens, output lens 106 may have a lower transmission efficiency, but the maximum value of the output angle can be about +/−50 degrees. As another example, a refractive double-convex lens can be made of material having a refractive index in the range from 0 to 2.

Turning now to FIG. 2, a side view of the first preferred embodiment of the Micro-Optical Beam Steering Magnifier 100 is shown with the input axis of input beam 110 shown as an input axis 212 forming a negative input angle 216 with system axis 108. Input beam 110 passes through input lens 104 and exits input lens 104 as intermediary beam 130. Input lens 104 directs intermediary beam 130 to output lens 106. Intermediary beam 130 passes through output lens 106 and exits lens 106 as output beam 150. Output axis 160 of output beam 150 now forms a positive output angle 220 with system axis 108. If input angle 216 is equal to, for example, negative four (−4) degrees, and M=5, then output angle 220 equals positive twenty (20) degrees.

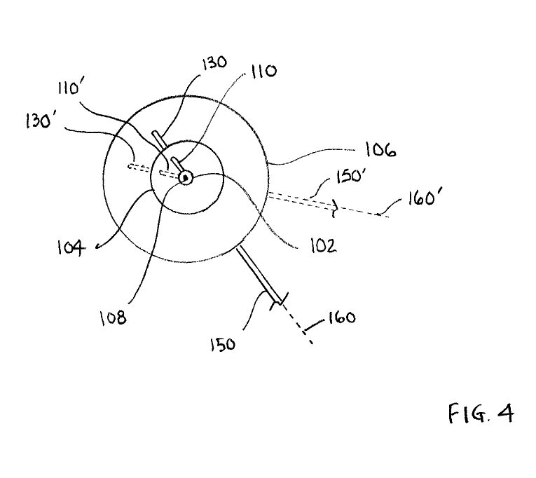

FIG. 3 is a side view of the first preferred embodiment of the Micro-Optical Beam Steering Magnifier 100, showing input axis 212 of input beam 110 now forming a positive input angle 322 with system axis 108. Input beam 110 passes through input lens 104 and exits input lens 104 as intermediary beam 130. Input lens 104 directs intermediary beam 130 to output lens 106. Intermediary beam 130 passes through output lens 106 and exits output lens 106 as output beam 150. Output axis 160 of output beam 150 now forms a negative output angle 326 with system axis 108. If input angle 322 is equal to, for example, positive four (4) degrees, and M=5, then output angle 326 equals negative twenty (20) degrees.

Referring now to FIG. 4, an end view of the Micro-Optical Beam Steering Magnifier 100 of the present invention shown in FIG. 1 includes a first typical input beam 110 being directed to a first location on input lens 104 which is refracted to intermediary beam 130 to pass through lens output lens 106 and as output beam 150 on axis 160. It is to be appreciated that the direction of input beam 110 may be changed to strike input lens 104 in different locations thereby re-directing output beam 150.

As an example, input beam 110′ may be directed to a different location on input lens 104 and refracted to intermediary beam 130′ to pass through lens output lens 106 and emerge as output beam 150′ on axis 160′. In this manner, by directing input beam 110 to different locations on input lens 104, the output beam 150 may be directed to any location within the field of view of output lens 106. This field of view includes a conical field, and may have angles 220 and 326 range between zero and a maximum angle to be determined by the shape, material, and refractive qualities of output lens 106.

It is to be appreciated that the angle magnification exhibited in the present invention is not limited to a single plane as shown in FIGS. 1-3. Rather, input beam 110 may be positioned on any portion of the input lens 104 creating an intermediary beam 130 in any desired plane which in turn creates an output beam having any axis within the field of view.

While there have been shown what are presently considered to be preferred embodiments of the present invention, it will be apparent to those skilled in the art that various changes and modifications can be made herein without departing from the scope and spirit of the invention. Thus, it is intended that the present invention cover the modifications and variations of this invention provided they come within the scope of the appended claims and their equivalents.

I claim:

1. A micro-optical beam steering angle magnifier, comprising:
linear referencing means for providing a reference line for measuring angles with respect to said referencing means in said magnifier;
producing means for producing an optical input beam having an optical input axis forming a variable input angle with respect to said referencing means;
input refracting means for refracting said input beam to produce an intermediary beam;
output refracting means for refracting said intermediary beam to produce an output beam having an output axis forming an output angle with respect to said referencing means of absolute magnitude greater than or equal to that of said input angle.

2. A micro-optical beam steering angle magnifier, comprising:
a system axis;
an input source, wherein said input source outputs an input beam having an input axis, wherein said input axis forms a variable input angle with said system axis;
an input lens, wherein said input beam passes through said input lens, wherein said input beam exits said input lens as an intermediary beam; and
an output lens, wherein said intermediary beam passes through said output lens, wherein said intermediary beam exits said output lens as an output beam having an output axis, wherein said output axis forms an output angle with said system axis of absolute magnitude greater than or equal to that of said input angle.

3. The magnifier of claim 2, wherein said input source is substantially paraxial with said system axis.

4. The magnifier of claim 2, wherein said input lens has an optical axis substantially coaxial with said system axis.

5. The magnifier of claim 2, wherein said output lens has an optical axis substantially coaxial with said system axis.

6. The magnifier of claim 2, wherein said input lens comprises an at least partly convex lens.

7. The magnifier of claim 2, wherein said input lens comprises a double convex lens.

8. The magnifier of claim 2, wherein said input lens comprises multiple elements.

9. The magnifier of claim 2, wherein said input lens comprises one or more holographic elements.

10. The magnifier of claim 2, wherein said input lens comprises one or more fresnel lenses.

11. The magnifier of claim 2, wherein said input lens comprises one or more aspheric elements.

12. The magnifier of claim 2, wherein said output lens comprises an at least partly convex lens.

13. The magnifier of claim 2, wherein said output lens comprises a double convex lens.

14. The magnifier of claim 2, wherein said output lens comprises multiple elements.

15. The magnifier of claim 2, wherein said output lens comprises one or more holographic elements.

16. The magnifier of claim 2, wherein said output lens comprises one or more fresnel lenses.

17. The magnifier of claim 2, wherein said output lens comprises one or more aspheric elements.

18. The magnifier of claim 2, wherein the ratio of the absolute magnitude of said output angle to the absolute magnitude of said input angle, is in the range from one-thousandth (0.001) to ten (10).

19. The magnifier of claim 2, wherein the magnitude of said output angle is in the range from minus fifty (−50) to plus fifty (50) degrees.

20. The magnifier of claim 2, wherein said input beam is collimated.

21. The magnifier of claim 2, wherein said input beam is aberrated.

22. The magnifier of claim 2, wherein said input beam is convergent.

23. The magnifier of claim 2, wherein said input beam is divergent.

24. An array of at least one of the magnifier of claim 2.

25. The array of claim 24, wherein said array is in two dimensions.

26. A micro-optical beam steering angle magnifier, comprising:
an optical system axis;
an optical input source, wherein said optical input source outputs an input beam having an input axis, wherein said input axis forms a variable input angle with said system axis;
a double-convex input lens having an optical axis substantially coaxial with said system axis, wherein said input beam passes through said input lens, wherein said input beam exits said input lens as an intermediary beam; and
a double-convex output lens having an optical axis substantially coaxial with said system axis, wherein said intermediary beam passes through said output lens, wherein said intermediary beam exits said output lens as an output beam having an output axis, wherein said output axis forms an output angle with said system axis, wherein the ratio of the absolute magnitude of said output angle to the absolute magnitude of said input angle, is in the range from one-thousandth (0.001) to ten (10).

27. An array of at least one of the magnifier of claim 26.

28. The array of claim 27, wherein said array is in two dimensions.
